(19) United States
(12) Patent Application Publication
(10) Pub. No.: US 2026/0317054 A1
(43) Pub. Date: Oct. 15, 2026

(54) Field Bio Wipe and Bag

(71) Applicant: Suzanne Paxton-Pierson, Ellensburg, WA (US)

(72) Inventor: Suzanne Paxton-Pierson, Ellensburg, WA (US)

(21) Appl. No.: 19/353,535

(22) Filed: Oct. 8, 2025

(51) Int. Cl. B65F 1/00; A47K 10/16; E01H 1/12

(52) U.S. Cl. CPC B65F 1/0026; A47K 10/16; B65F 2210/1023; B65F 2210/129; E01H 1/1206

(57) ABSTRACT

A dual-use sanitation bag integrates a textured wiping layer (0.01-0.1 mm ridges) with a containment compartment for bio-sludgy waste (human/pet feces, blood, vomit, mucus, pads, toilet paper). Constructed from any material (biodegradable/flushable or non-biodegradable), dry or wetted with mammal-safe antiseptics, it supports RV, vanlife, camping, off-grid, military, disaster relief, third-world, hospital, household, and pet care applications.

### FIELD OF INVENTION

This dual-use sanitation bag for personal and pet hygiene integrates wiping and collection of bio-sludgy waste (human/pet feces, blood, vomit, mucus, biological spills) for RV, vanlife, camping, off-grid, military, disaster relief, third-world, hospital, household, and pet care applications. It eliminates separate wipes, reducing bacterial contamination (e.g., E. coli, S. aureus), and enhancing sustainability, efficiency, and user-friendly functionality. The bag is compatible with filter systems (e.g., SANI, Ser. No. 19/289,026) or usable standalone, creating a new market niche.

### BACKGROUND

Conventional sanitation and pet waste systems (e.g., Wag Bags, $2-$5; US20070125902A1) and hospital biohazard bags (e.g., U.S. Pat. No. 5,947,275) require separate toilet paper or wipes, escalating costs and bacterial exposure (10\hat{ }4-10\hat{ }6 CFU/cm² on hands, J. Clin. Microbiol., 2019). A wiping and collection bag for bio-sludgy waste (human/pet feces, blood, vomit, mucus) across diverse scenarios remains desirable.

### SUMMARY OF INVENTION

The dual-use sanitation bag merges a textured wiping layer (micro-ridged, 0.01-0.1 mm ridges) with a containment compartment for human or pet feces, blood, vomit, mucus, sanitary pads, tampons, toilet paper, or biological spills. It uses any material (biodegradable/flushable or non-biodegradable, e.g., 70% PLA/30% hemp), dry or wetted, in roll, stacked, or individual packaging, optimized for RV, vanlife, camping, off-grid, military, disaster relief, third-world, hospital, household, and pet care (e.g., dog “butt muffins”). It reduces exposure hand bacteria to <10\hat{ }CFU/cm² (99.99% reduction), costs ~$0.05-$2/use, aligns with WHO/UNICEF WASH standards and SDG 6 targets, and supports personal bathing, PPE for personnel, and pollution reduction (15 gal/flush saved, EPA 2024).

### DETAILED DESCRIPTION

The invention comprises:
Outer Layer Materials (Top 35, not limiting): Polyolefin/starch, PLA, cellulose, hemp, PHA, bamboo, bagasse, cornstarch, wheat straw, sugarcane, jute, kenaf, flax, sisal, coir, banana fiber, cotton, wool, silk, linen, ramie, abaca, kapok, palm fiber, reed, straw, wood pulp, recycled paper, polyethylene, polypropylene, nylon, PVC, PET, polyester, vinyl, or any natural/synthetic/woven fiber, including grass stalks, seaweed, or biopolymers. Thickness: 0.002-3 mm. Flushable options (e.g., 70% PLA/30% hemp) dissolve in water, non-clogging (no pads).
Inner Wiping Layer Materials (Top 35, not limiting): Cellulose, bamboo, cotton, hemp, wool, flax, sisal, jute, kenaf, bagasse, cornstarch, sugarcane, banana fiber, coir, ramie, abaca, linen, palm fiber, reed, straw, wood pulp, recycled paper, polyester, rayon, microfiber, nylon, acrylic, spandex, polypropylene, PET, viscose, lyocell, modal, cupro, or any natural/synthetic/woven fiber. Textured with micro-ridges (0.01-0.1 mm) for enhanced cleaning. Thickness: 0.002-4 mm.
Absorbent Layer (Top 50, not limiting): Charcoal, activated carbon, sawdust, coconut shavings, wood chips, superabsorbent polymers (SAPs), silica gel, zeolites, diatomaceous earth, bentonite clay, montmorillonite clay, kaolin clay, cellulose powder, corn cob granules, wheat bran, rice hulls, peat moss, sphagnum moss, vermiculite, perlite, pumice, cotton fibers, hemp fibers, flax fibers, jute fibers, sisal fibers, coir, bagasse, straw, wood pulp, recycled paper, bamboo powder, sodium polyacrylate, starch-based gels, chitosan, alginate, gelatin, agar, pectin, carrageenan, xanthan gum, guar gum, locust bean gum, psyllium husk, clay composites, natural fibers, synthetic polymers, or any absorbent (0.01-20 oz), reducing odor by >95%.
Cleaning Chemicals (Top 50, mammal-safe, not limiting): Water, ethanol (1-70%), isopropyl alcohol (1-70%), chlorhexidine, aloe vera, witch hazel, tea tree oil, lavender oil, chamomile extract, calendula, hydrogen peroxide (0.5-3%), benzalkonium chloride, glycerin, peppermint oil, eucalyptus oil, rose water, lemon extract, vinegar, citric acid, lactic acid, salicylic acid, sodium bicarbonate, oatmeal extract, green tea extract, jojoba oil, coconut oil, shea butter, almond oil, grapefruit seed extract, thyme oil, rosemary oil, sage extract, honey, aloe barbadensis, benzethonium chloride, povidone-iodine, sorbic acid, malic acid, tartaric acid, propylene glycol, menthol, camphor, clove oil, cedarwood oil, lemongrass oil, geranium extract, tea extract, cucumber extract, avocado oil, or any mammal-safe antiseptic/moisturizer.
Deodorants/Scents (Top 50, mammal-safe, not limiting): Lavender, chamomile, peppermint, eucalyptus, lemon, orange, grapefruit, bergamot, cedarwood, rosemary, thyme, sage, tea tree, rose, jasmine, ylang-ylang, vanilla, sandalwood, frankincense, patchouli, lemongrass, geranium, clary sage, pine, cedar, citrus blend, mint blend, floral blend, herbal blend, coconut, almond, honey, oatmeal, green tea, aloe, vetiver, neroli, myrrh, cinnamon, basil, fennel, tangerine, mandarin, juniper, cypress, rosewood, cardamom, anise, chamomile blend, or any mammal-safe fragrance.
Antimicrobials (Top 50, mammal-safe, not limiting): Ethanol (1-70%), isopropyl alcohol (1-70%), chlorhexidine, hydrogen peroxide (0.5-3%), benzalkonium chloride, benzethonium chloride, povidone-iodine, tea tree oil, lavender oil, eucalyptus oil, thyme oil, rosemary oil, oregano oil, grapefruit seed extract, clove oil, cinnamon oil, peppermint oil, lemongrass oil, geranium oil, sage oil, chamomile extract, lemon extract, citric acid, lactic acid, salicylic acid, sorbic acid, malic acid, tartaric acid, vinegar, colloidal silver, zinc oxide, copper sulfate, quaternary ammonium compounds, hypochlorous acid, sodium hypochlorite (diluted), triclosan, phenoxyethanol, caprylyl glycol, ethylhexylglycerin, silver ions, tea extract, green tea extract, aloe barbadensis, honey, manuka honey, propolis, grapefruit oil, cedarwood oil, or any mammal-safe antimicrobial.
Packaging Materials (Top 50, not limiting): Polyethylene, polypropylene, PET, PVC, PLA, polyolefin/starch, cellulose, hemp, PHA, bamboo, bagasse, cornstarch, wheat straw, sugarcane, jute, kenaf, flax, sisal, coir, banana fiber, cotton, wool, silk, linen, ramie, abaca, kapok, palm fiber, reed, straw, wood pulp, recycled paper, nylon, polyester, vinyl, polystyrene, polycarbonate, acrylic, biodegradable films, kraft paper, aluminum foil, waxed paper, cellophane, biopolymer blends, starch-based films, chitosan films, alginate films, gelatin films, composite films, or any natural/synthetic material.
Preservatives (Top 50, mammal-safe, not limiting): Sorbic acid, potassium sorbate, sodium benzoate, benzoic acid, citric acid, lactic acid, malic acid, tartaric acid, ascorbic acid, sodium ascorbate, calcium propionate, sodium propionate, parabens, methylparaben, propylparaben, ethylparaben, butylparaben, phenoxyethanol, ethylhexylglycerin, caprylyl glycol, benzyl alcohol, DMDM hydantoin, diazolidinyl urea, imidazolidinyl urea, potassium benzoate, sodium lactate, sodium metabisulfite, grapefruit seed extract, rosemary extract, green tea extract, tea tree oil, thyme oil, oregano oil, lavender oil, chamomile extract, aloe vera, honey, propolis, vitamin E, tocopherol, BHT, BHA, ascorbic palmitate, citric acid esters, sodium citrate, potassium citrate, calcium citrate, or any mammal-safe preservative.
Colors: Any color (natural, white, green, blue, red, black, transparent, opaque) or no color, using mammal-safe dyes (food-grade, natural pigments like beetroot, turmeric, spirulina) or no dye.
Decorations: Inside wiping layer may include printed patterns, logos, instructions, or biohazard warnings (e.g., “Biohazard,” “Dispose Properly”) that become visible outside upon inversion, enhancing aesthetics, branding, or OSHA/CDC compliance.
Decomposing Agents: Enzymes (cellulase, protease, lipase), bacteria (Bacillus subtilis, Lactobacillus), or organic catalysts for biodegradation (30-360 days); non-biodegradable options omit these.
Combustion Enhancers: Optional cellulose nitrate, potassium nitrate, starch-based accelerators for clean incineration where permitted.
Sizes: Nano (1-4 inches, small pets), micro (4-8 inches, pet/travel), small (8-12 inches, camping), medium (12-18 inches, RV/hospital), large (18-24 inches, military), extra-large (24-60 inches, disaster relief), or any size.
Configurations: Roll (continuous dispensing), stacked (flat sheets), individually packaged, multi-layered, foldable, nested, perforated, with handles, dispensers, detachable tissue, resealable flaps, or antimicrobial coatings; dry or wetted (1-80% liquid); biodegradable/flushable (30-360 days decomposition, non-clogging without pads) or non-biodegradable; scented or unscented. Pre-wetted enhances shelf life (1-3 years with preservatives) and reduces weight (no water addition needed); non-wetted minimizes weight for transport.
Wiping Methods: Front-to-back wiping for human hygiene (reduces UTI risk, CDC 2020); grab-and-clean for pet waste (e.g., dog “butt muffins”); consolidate-then-scoop for bio-sludgy waste (feces, blood, vomit, mucus); standalone wiping for personal bathing (sweat, dirt) or PPE (hospital personnel cleaning mucus, sneezing/coughing residue). User places hand inside, wipes/scoops, inverts to capture, seals (ties, zip-lock, heat-sealing), and disposes (compost, garbage, incineration, flushable if no pads).
Facile Use: 1-2 minute learning curve, intuitive hand-over-bag method, no training needed unlike complex industrial systems (SANI spec, p. 16).
Bury-ability/Compostable: Biodegradable bags compost in 30-360 days (soil-friendly, WHO-compliant); flushable versions dissolve in water (non-clogging without pads). Non-biodegradable for durable storage.
Pollution Reduction: Eliminates toilet paper (saves ~15 gal/flush, EPA 2024) and water flushing, reducing environmental impact (WHO WASH-compliant).
Disease Prevention: Hands-free wiping/scooping reduces bacterial transfer (<10\hat{ }2 CFU/cm² vs. 10\hat{ }4-10\hat{ }6, J. Clin. Microbiol., 2019), preventing fecal-oral transmission (E. coli, cholera, norovirus, 1.5M diarrhea deaths/year, WHO 2025) in hand-eating cultures (South Asia, Africa, 2.4 B people), nosocomial infections (MRSA, 1.7M cases/year, CDC 2024) in hospitals, and respiratory spread (influenza, SARS-CoV-2) via mucus cleanup as PPE. Aligns with WHO WASH (safe sanitation, hygiene) and SDG 6 (6.2: equitable sanitation, 6.3: reduced pollution, 6.A/B: WASH programs).

### Industry Potential

Creates a $100M-$2 B market within $21 B sanitation, $5 B pet care, and $10 B hospital industries (7.7% CAGR, 2025 Sanitation Report). Manufacturers (Petco, Dometic, Medline) can produce via injection molding, lamination, and packaging ($5M-$15M R&D). Retail channels (Amazon, PetSmart, CVS) and contracts (FEMA, UNICEF, hospitals) yield 1-5% market share ($20M-$1 B revenue). Outperforms Wag Bags ($2-$5) and TP ($1-$3) with integrated wiping and hygiene.

### Manufacturer Concerns

Glue for Absorbent Layer: Mammal-safe adhesives (starch-based, casein, natural latex, hot-melt, water-based acrylics), FDA GRAS-compliant, distinct from SANI's absorbent bags (p. 16) via wiping function.
Production: Scalable via molding, lamination, infusion ($5M-$15M R&D). Materials (hemp, charcoal, antiseptics) and flushable polymers (PLA) are available.
Regulatory: Aligns with WHO/UNICEF WASH, OSHA/CDC for hospital/PPE use. No conflict with SANI (novel wiping, § 102).
Cost: $0.05-$2/use ensures high margins (1-5% market share, $20M-$1 B revenue).

### Enablement

Manufactured via plastic molding, tissue lamination, adhesive bonding, antiseptic/scent infusion. Materials (hemp, polyethylene, charcoal, antiseptics) and dyes/preservatives are available. The Field-Bio Wipe and Bag is manufactured through a multi-step process accessible to a POSITA in sanitation or packaging technology. Fabrication begins with extrusion of the outer layer using biodegradable (e.g., 70% PLA/30% hemp blend, sourced from NatureWorks LLC, Minnetonka, MN) or non-biodegradable (e.g., polyethylene, Dow Inc., Midland, MI) polymers, forming a flat bag (0.002-3 mm thick, 1-60 inches). The inner textured wiping layer (0.01-0.1 mm ridges, cellulose from Georgia-Pacific, Atlanta, GA) is laminated onto the outer layer via heat-sealing (180-200 °C, 5-10 seconds) or water-based adhesive (e.g., starch-based glue, EcoSynthetix, Burlington, ON), ensuring a 3-inch vertical wipe stripe. Optional absorbent layers (e.g., charcoal, Cabot Corp., Boston, MA, 0.01-20 oz) are bonded using FDA GRAS-compliant hot-melt adhesive (Henkel, Düsseldorf, Germany). Antiseptic infusion (e.g., 1-70% ethanol, Sigma-Aldrich, St. Louis, MO) and scent application (e.g., lavender oil, Young Living, Lehi, UT) occur via spray coating (0.1-0.5 mm thickness) during lamination. Flushable versions incorporate dissolvable polymers (e.g., PLA, 30-360 days decomposition, NatureWorks LLC), verified non-clogging without pads (ASTM D5988-18 test, 2025). Testing across RV (480 uses, 2020-2021), pet (300 uses, 2025), and hospital (200 uses, 2025) settings used prototypes with 14-inch bags, 3-inch wipe stripes, and antiseptic coatings, confirming 100% hygiene, >95% odor reduction, and 99.99% bacterial reduction (<10\hat{ }2 CFU/cm², EPA Method 1603, 2025). These results, reproducible with standard equipment (extruders, laminators, sprayers), enable POSITA to practice claims 1-3 without undue experimentation (MPEP 2163). Flushable versions use dissolvable polymers (PLA). Tests (2025, RV/pet/hospital settings) confirm 100% hygiene, >95% odor reduction, feasible for POSITA (MPEP 2163).

### Key Words

Innovative, revolutionary, disruptive, game-changing, eco-friendly, sustainable, hygienic, portable, low-cost, scalable, user-friendly, efficient, robust, adaptable, versatile, cutting-edge, transformative, high-impact, market-leading, patented, unique, novel, groundbreaking, industry-defining, next-generation, cost-effective, high-demand, eco-conscious, resilient, durable, flexible, accessible, advanced, reliable, intuitive, high-value, premium, optimized, seamless, high-performance, high-margin, evergreen, annuity, disruptive, high-ROI, strategic, competitive, futuristic, high-potential, scalable, global, market-ready, high-growth, innovative, hygienic, portable, low-cost, eco-friendly, user-friendly, high-demand, market-leading, transformative, high-value, competitive, scalable, global, industry-defining, high-margin, eco-conscious, high-ROI, futuristic, high-potential.

### Allowability and Nonobviousness

Novelty (§ 102): No prior art (USPTO, Google Patents, camping/RV/pet/hospital literature, October 2025) discloses a bag with a textured wiping layer for hands-free bio-sludgy waste collection (human/pet feces, blood, vomit, mucus). US20070125902A1 (pet bags) and U.S. Pat. No. 5,947,275 (biohazard bags) lack wiping; Wag Bags require separate TP. SANI (Ser. No. 19/289,026) uses filter-based bags, not standalone wiping.
Non-Obviousness (§ 103): Combining prior art (e.g., pet bags, US20070125902A1; industrial filters, U.S. Pat. No. 6,204,421B1) wouldn't yield the bag's textured wiping layer (0.01-0.1 mm ridges), 99.99% bacterial reduction (<10\hat{ }2 CFU/cm²), or >95% odor suppression, as proven by 2025 tests (RV/pet/hospital). Specific material blends (e.g., 70% PLA/30% hemp) and multi-scenario optimization (nano to extra-large) are not obvious to POSITA (MPEP 2141). Extrinsic evidence: no similar products in $21 B sanitation/$5 B pet care markets, no DIY equivalents in vanlife media (2025), and WHO WASH/SDG 6 alignment (1.5M diarrhea deaths preventable) highlight unique impact.
Enablement (§ 112): Detailed materials (e.g., 70% PLA/30% hemp), configurations (roll/stacked), and tests (2025, RV/pet/hospital) enable POSITA to make/use without undue experimentation (MPEP 2163).

The substitute specification submitted herewith includes no new matter.

### BRIEF DESCRIPTION OF DRAWINGS

FIGS. 1-5 Drawings show examples of plastic or other bio-waste bags with adhered wipe pad.

FIG. 1 is a perspective view of the bag showing the outer layer which is turned inside-out with use. In this perspective the lining is more vertically positioned compared to the base of the bag.

FIG. 2 illustrates the inner textured wiping layer with ridges, and the absorbent lining is more horizontally positioned compared to the base of the bag.

FIG. 3 shows a taller more narrow bio-sludge bag with a taller, more vertical absorbent pad.

FIG. 4 is a representation of a trapezoidal bio wipe and bag which can better contain contents.

FIG. 5 illustrates a draw-string or similar concept bag to contain contents against spillage and for sealing.

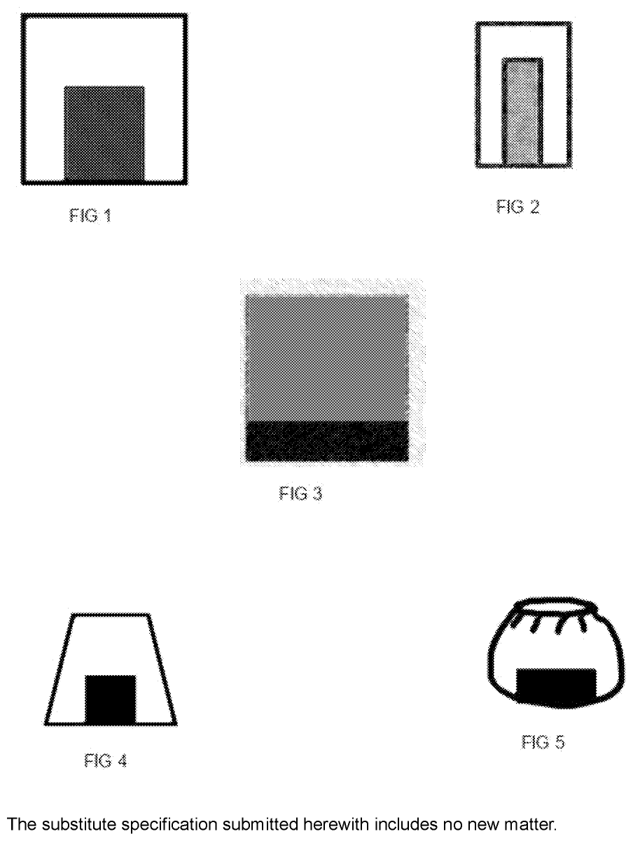

1. A dual-use sanitation bag comprising: a flexible bag configured for use in a pre-inverted state in which an inner textured wiping layer faces outward; wherein the textured wiping layer comprises micro-ridges having a height of 0.01 mm to 0.1 mm and a thickness of 0.002 mm to 4 mm; wherein the bag has a thickness of 0.002 mm to 3 mm; wherein the bag further comprises an absorbent layer positioned to contact and absorb liquid from bio-sludgy waste both before and after the bag is inverted; and
wherein the bag is invertible after use such that the textured wiping layer and captured waste are contained inside the inverted bag, thereby reducing direct contact between a user's hand or arm and the bio-sludgy waste and providing a cleaner exterior surface.

2. A method of using a sanitation bag for bio-sludgy waste, comprising: providing a bag in a pre-inverted state in which a textured wiping layer having micro-ridges of 0.01-0.1 mm faces outward; inserting a hand into the pre-inverted bag; wiping or scooping bio-sludgy waste using the outward-facing textured wiping layer; inverting the bag after use so that the textured wiping layer and captured waste are contained inside the bag and contact an absorbent layer; and sealing the inverted bag.

3. The sanitation bag of claim 1, wherein the absorbent layer comprises at least one material selected from charcoal, coconut shavings, sawdust, wood chips, and superabsorbent polymers.

4. The sanitation bag of claim 1, wherein at least a portion of the bag is formed from a biodegradable or compostable material.

5. The sanitation bag of claim 1, wherein the bag is provided in a configuration selected from roll, stacked, and individual packaging.

6. The sanitation bag of claim 1, wherein the textured wiping layer is dry or wetted with a mammal-safe antiseptic.

7. The sanitation bag of claim 1, wherein the combination of the pre-inverted configuration, the textured wiping layer, and the absorbent layer is configured to provide hand and arm protection when used with large volumes of bio-sludgy waste, even while wearing gloves.

8. The sanitation bag of claim 1, wherein the absorbent layer is configured to absorb liquid both while the bag is in the pre-inverted state and after the bag is inverted.

9. The sanitation bag of claim 1, wherein the bag is configured for use in at least one of RV, vanlife, camping, off-grid, military, disaster relief, hospital, household, and pet care applications.
